(19) United States
(12) Patent Application Publication
(10) Pub. No.: US 2021/0010904 A1
(43) Pub. Date: Jan. 14, 2021

(54) METHOD AND APPARATUS FOR EVALUATING DEGREE OF INJURY TO RIDER'S HEAD COLLIDING WITH PAVEMENT, AND METHOD FOR TESTING APPARATUS

(71) Applicant: CHANG'AN UNIVERSITY, Xi'an City, Shaanxi Province (CN)

(72) Inventors: Aimin SHA, Xi'an City, Shaanxi Province (CN); Jie GAO, Xi'an City, Shaanxi Province (CN); Bo LUAN, Xi'an City, Shaanxi Province (CN); Yuqiao TAN, Xi'an City, Shaanxi Province (CN); Zheng TONG, Xi'an City, Shaanxi Province (CN)

(21) Appl. No.: 16/968,879

(22) PCT Filed: Dec. 13, 2018
(86) PCT No.: PCT/CN2018/120916

§ 371 Date: Aug. 11, 2020

(30) Foreign Application Priority Data
Feb. 11, 2018 (CN) 201810156625.5

(51) Int. Cl. G01M 17/007; G01M 7/08

(52) U.S. Cl. CPC G01M 17/0078; G01M 7/08

(57) ABSTRACT

The present disclosure provides a method and an apparatus for evaluating a degree of injury of a rider's head colliding with a pavement and a test method for testing the apparatus. An impact acceleration of a head model falling from a certain height and hitting the pavement is obtained through a self-made test apparatus, a TBS value is calculated after processing the obtained impact acceleration, and a possibility of the degree of the injury to the rider's head colliding on a test pavement after falling is obtained by inquiring a look-up table of possibility of injury degree of the head of the rider corresponding to the TBS provided by the present disclosure, for evaluating safety hazard when falling on the pavement. Compared with the related art, the method and the apparatus provided by the present disclosure for evaluating the degree of the injury of the rider's head colliding with the pavement is of great significance for quantitatively describing whether the pavement can guarantee safety of a bicycle rider to the greatest extent, so as to provide effective methods and tools for construction of urban bicycle lanes and evaluation of urban bicycle lanes.

### TECHNICAL FIELD

The present disclosure relates to the field of transportation engineering, and in particular, to a method and apparatus for evaluating a degree of injury to a rider's head colliding with a pavement, and a method for testing the apparatus.

### BACKGROUND

China is known as a “kingdom of bicycles” and has had a relatively large number of bicycles since its founding. Nowadays, with popularization of urban public bicycles and shared bicycles and the country's strong advocacy for green transportation travel, bicycle riding is becoming a green and healthy way of travel, which is preferred by people. In a future development plan of a city, an independent-running bicycle transportation system is coming out, and in recent years, independent bicycle lanes especially for bicycles are gradually being built, such as a cycling lane around the Qinghai Lake and an aerial cycling lane in Xiamen, and the bicycle transportation system has broad development prospects.

However, with the continuous expansion of bicycle traffic, urban infrastructure construction has not fully considered traffic safety of bicycle riders. The bicycle has a simple structure, is relatively light, and has poor protection for the riders, and is a vulnerable means in transportation tools. When riding a bicycle, rollover often easily occurs to the rider due to influence of traffic conditions and natural environments. Once the rider falls off the bike, it will often cause serious personal injury. Therefore, when designing bicycle lanes, possible accidental fall risk of riders should be fully taken into account, and a safety assessment on the serious injury of head landing should be conducted for the selected surface material of the pavement, to reduce the degree of possible injury of the head falling from a high position of the bicycle.

Regarding the head injury of the riders, research papers “Research on Dynamic Response and Injury of Riders Based on Reconstruction of Automobile-Bicycle Collision Accidents” and “Dynamic Response of Pedestrian Head Based on Reconstruction of Vehicle-Human Collision Accidents” discuss injury of the rider's head colliding with a car windshield but do not provide testing and grading methods for injury of a human head colliding with a pavement. No relevant content was found in Chinese patents.

At present, countries around the world have not established a unified standard and test method for evaluating the injury caused by bicycle lanes to riders, and scientific research has not been carried out research on this issue. This is not conducive to the development of bicycle transportation systems, but also neglects the safety of bicycle riders.

### SUMMARY

In order to solve the above problems, the present disclosure provides a method and apparatus for accurately evaluating degree of injury to a bicycle rider falling on a certain section of a pavement, and a method for testing the apparatus.

The present disclosure provides a method for evaluating a degree of injury to a rider's head colliding with a pavement. The method includes:

1) for different pavement conditions, calculating a TBS value according to a following formula:

$$TBS = {\{ {( {t}_{2} - {t}_{1} ) [ \frac{{\int }_{{t}_{1}}^{{t}_{2}} a ( t ) dt}{{t}_{2} - {t}_{1}} ]}^{\frac{5}{2}} \}}_{max} ,$$

where a(t) represents measured composite acceleration in a unit of g, g=9.8 m/s², t₁ and t₂ respectively represent two moments during impact, and t₂-t₁ represents a certain time interval between a beginning moment and an end moment of recording, and in this time interval, the TBS value takes a maximum value; and

2) determining the degree of the injury using the obtained TBS value. Degrees of injury are classified into six levels including mild injury, moderate injury, severe injury, serious injury, critical injury and fatal injury based on degree of the injury or threat to a human body. Each of the six levels corresponds to a range of the TBS value. That is, a look-up table of a possibility of injury degree provides possibility of injury of respective levels corresponding to the TBS value for intuitive judgment.

Preferably, the pavement includes an asphalt pavement, a concrete pavement, a sidewalk pavement, a bicycle lane elastic pavement, a bridge deck pavement, a sports ground or a safety floor.

The present disclosure further provides an apparatus for evaluating a degree of injury to a rider's head colliding with a pavement, and the apparatus includes a collision impact system configured to test acceleration, a data acquisition system configured to acquire the tested acceleration and store or transmit the tested acceleration, and a data analysis system configured to receive and analyze the acceleration transmitted from the data acquisition system.

Preferably, the collision impact system includes a down-sliding rail vertically disposed and provided with a height control device in a vertical direction, a supporting base plate arranged at a bottom of the down-sliding rail, and a head model sliding along the down-sliding rail. Both ends of the down-sliding rail are respectively provided with ring hoops, an acceleration sensor is provided in the head model, and the acceleration sensor is connected to the data acquisition system.

Preferably, the data acquisition system includes a constant-current power adapter connected to the acceleration sensor and configured to supply power to the data acquisition system, a data acquisition card connected to the acceleration sensor, and data storage software, and the data analysis system includes software and a computer that outputs and calculates a measured acceleration value.

Preferably, the head model is formed by a combination of a hemisphere and an equal radius cylinder and is made of aluminum alloy, the hemisphere of the head model has a diameter of 160 mm±5 mm and a mass of 4.6 kg±0.05 kg, and a side of the head model is provided with a columnar through groove closely attached to the down-sliding rail.

Preferably, the down-sliding rail comprises three mutually parallel cylindrical metal rods, each of which has a radius of 9 mm, and each of the ring hoops has an inner diameter of 89 mm.

Preferably, the acceleration sensor is a piezoelectric sensor and configured to measure acceleration in a direction perpendicular to the pavement, the acceleration sensor is located at a center of gravity of the head model, and a deviation of an axis of the acceleration sensor from an axis of the head model is smaller than or equal to 5°.

The present disclosure further provides a method for testing an apparatus for evaluating a degree of injury to a rider's head colliding with a pavement, including:

1) test preparation including: selecting a test site, cleaning a part of the pavement at the test site using a small brush, brushing an inner side of a down-sliding rail with lubricating oil to reduce impact of friction on a falling of a head model, connecting an acceleration sensor with a power adapter and computer data acquisition software, and checking overall running conditions;

2) test operation including: placing the collision impact system at the test site, adjusting a height control device to a specified position, manually raising the head model slowly to a fixed height, and after ensuring that the head model and each of three rails are in good contact and readings of the acceleration sensor are stable, releasing the head model to cause it to fall vertically along the down-sliding rail and collide with and impact on a pavement material; and at each of falling heights, repeating the releasing for three times, and outputting data;

3) data acquisition including: outputting falling time and acceleration data through an acceleration data output port, and after the colliding is completed and the readings have been recorded, stopping reading from the acceleration sensor, and saving the measured acceleration data; and

4) data processing including: linearly fitting a series of two-dimensional coordinates (tᵢ, aᵢ) (i=1, . . . n) of certain moments and vertical acceleration at the certain moments that are obtained by the acceleration sensor, and then plotting a relationship chart between acceleration and time.

Compared with the related art, the present disclosure provides the method for evaluating the degree of the injury of the rider's head colliding with the pavement, further provides a corresponding test apparatus especially for this method, and provides a test method using the apparatus. This is of great significance for quantitatively describing whether the pavement can guarantee safety of the bicycle rider to the greatest extent, so as to provide effective methods and tools for construction of urban bicycle lanes and evaluation of urban bicycle lanes.

### BRIEF DESCRIPTION OF DRAWINGS

FIG. 1 is a schematic diagram of an apparatus for evaluating a degree of injury to a rider's head colliding with a pavement according to an embodiment of the present disclosure.

FIG. 2 is a schematic diagram of a head model illustrated in FIG. 1.

FIG. 3 is a top view illustrating a down-sliding rail and a ring hoop illustrated in FIG. 1.

FIG. 4 is a schematic diagram of a height control device illustrated in FIG. 1.

FIG. 5 is an example of impact acceleration data.

FIG. 6 illustrates an acceleration-time relationship chart in for a single collision.

FIG. 7 illustrates a displacement-time relationship chart for a single collision.

FIG. 8 is a diagram illustrating impact acceleration measured in Embodiment 1.

FIG. 9 is a diagram illustrating impact acceleration measured in Embodiment 2.

FIG. 10 is a diagram illustrating impact acceleration measured in Embodiment 3.

### DESCRIPTION OF EMBODIMENTS

In order to make objectives and advantages of the present disclosure clearer, the present disclosure will be further described in detail in conjunction with the following embodiments.

Embodiments of the present disclosure provide a method for evaluating a degree of injury to a rider's head colliding with a pavement, and the method includes following steps.

At step S1, for different pavement conditions, a TBS value is calculated according to a following formula:

$$TBS = {\{ {( {t}_{2} - {t}_{1} ) [ \frac{{\int }_{{t}_{1}}^{{t}_{2}} a ( t ) dt}{{t}_{2} - {t}_{1}} ]}^{\frac{5}{2}} \}}_{max} ,$$

where TBS is head injury, a(t) is measured composite acceleration in a unit of g (g=9.8 m/s²), t₁ and t₂ respectively represent two moments during impact, t₂-t₁ represents a certain time interval between a beginning moment and an end moment of recording, and in this time interval, TBS has a maximum value (t₂−t₁≤15 ms).

This calculation formula solves the time and the acceleration and calculates the index TBS, to measure a relation value between the acceleration and the time under different pavements and different heights. A value of the TBS is used to determine possibility of injury at each level. In turn, it is used to determine possibility of the injury to a falling head by a material of the pavement surface.

The pavement includes an asphalt pavement, a concrete pavement, a sidewalk pavement, a bicycle lane elastic pavement, a bridge deck pavement, a sports ground or a safety floor.

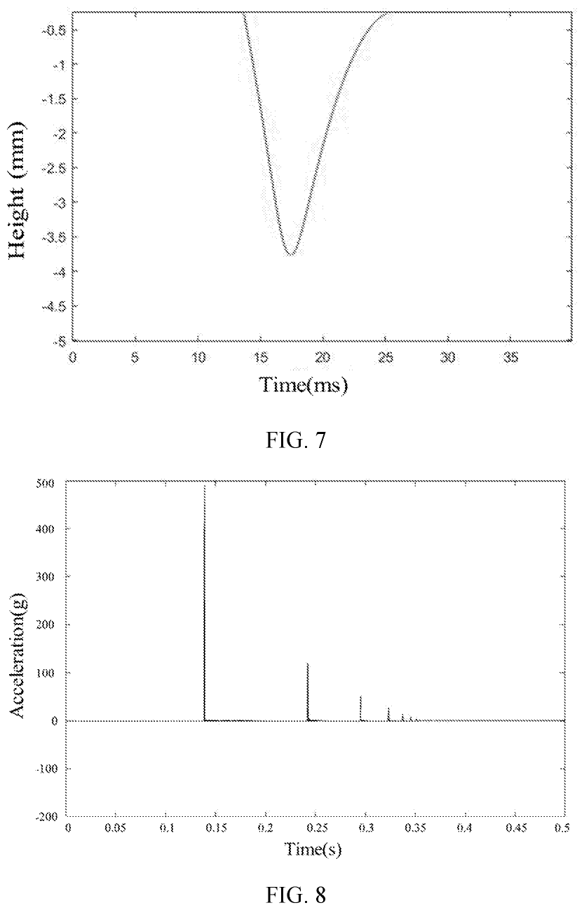

A relationship chart between the acceleration and the time and a relationship chart between displacement and the time near a time of a certain impact are selected, as shown in FIG. 6 and FIG. 7.

Taking t₂−t₁=15 ms as an example, [t₃−7.5, t₃+7.5] is selected as an initial interval to calculate a value of TBS₀, and values of TBS within a time interval [t₃−7.5+Δ, t₃+7.5+Δ] are calculated and compared with TBS₀, to determine whether TBS₀ is a maximal value.

At step S2, searching from a look-up table of possibility of injury degree provided by the present disclosure, as shown in Table 1, is performed based on the TBS values calculated under different pavements and different heights, and possibilities at different injury levels corresponding to the TBS values are provided. The degrees of injury or threat to a human body is classified into six levels including mild injury, moderate injury, severe injury, serious injury, critical injury, and fatal injury, so that the degree of the injury to the rider's head colliding with the pavement can be more intuitively evaluated. A safety critical value of the TBS value is 1000. When the calculated TBS value is 1000, for ordinary men, the possibility critical head injury is 2%, the possibility of serious head injury is 16%, the possibility of severe head injury is 36%, the possibility of moderate head injury is 35%, and the possibility of mild head injury is 11%. When the TBS value is greater than 1000, it is considered that the current tested pavement has a relatively large safety risk to the fall injury to the rider's head.

TABLE 1
Look-up table of possibility of injury degree (%)

| TBS | No | Mild | Moderate | Severe | Serious | Critical | Fatal |
|---|---|---|---|---|---|---|---|
| Value | Injury | Injury | Injury | Injury | Injury | Injury | Injury |
| <20 | 99.9 | — | — | — | — | — | — |
| 100 | 91 | 7 | 2 | — | — | — | — |
| 200 | 72 | 19 | 7 | 2 | — | — | — |
| 300 | 55 | 29 | 11 | 4 | 1 | — | — |
| 400 | 31 | 41 | 19 | 7 | 2 | — | — |
| 500 | 18 | 42 | 26 | 11 | 3 | — | — |
| 600 | 10 | 36 | 35 | 15 | 4 | — | — |
| 700 | 6 | 28 | 41 | 19 | 6 | — | — |
| 800 | 2 | 21 | 42 | 25 | 9 | 1 | |
| 900 | 1 | 15 | 39 | 31 | 10 | 2 | |
| 1000 | — | 11 | 35 | 36 | 16 | 2 | — |
| 1100 | — | 8 | 30 | 38 | 20 | 4 | — |
| 1200 | — | 4 | 25 | 41 | 24 | 6 | — |
| 1300 | — | 3 | 20 | 39 | 30 | 8 | — |
| 1400 | — | 2 | 14 | 37 | 34 | 12 | 1 |
| 1500 | — | — | 11 | 29 | 40 | 18 | 2 |
| 1600 | — | — | 8 | 27 | 39 | 22 | 4 |
| 1700 | — | — | 6 | 22 | 37 | 29 | 6 |
| 1800 | — | — | 4 | 18 | 34 | 35 | 9 |
| 1900 | — | — | 3 | 13 | 28 | 39 | 17 |
| 2000 | — | — | 2 | 9 | 21 | 43 | 26 |
| 2100 | — | — | 2 | 7 | 17 | 36 | 38 |
| 2200 | — | — | 1 | 5 | 12 | 29 | 53 |
| 2300 | — | — | — | 4 | 8 | 21 | 67 |
| 2400 | — | — | — | 3 | 6 | 13 | 78 |
| 2500 | — | — | — | 2 | 3 | 8 | 87 |
| 2600 | — | — | — | 1 | 2 | 5 | 92 |
| 2700 | — | — | — | — | 2 | 4 | 94 |
| 2800 | — | — | — | — | 1 | 2 | 98 |
| 2900 | — | — | — | — | — | 1 | 99 |
| >3000 | — | — | — | — | — | — | 99.9 |

Note:
It is stipulated that the calculated TBS value is rounded up into an integer and searching from the table is performed after obtaining a whole hundred value.

It should be noted that Table 1 is obtained and verified through the inventor through a large number of actual tests on the basis of consulting domestic and foreign literatures.

As shown in FIG. 1, an embodiment of the present disclosure provides an apparatus for evaluating a degree of injury to a rider's head colliding with a pavement, including a collision impact system 1, a data acquisition system 2, and a data analysis system 3.

The collision impact system 1 is configured to test acceleration and includes a down-sliding rail 5 vertically disposed, a supporting base plate 6 provided at a bottom of the down-sliding rail 5, and a head model 4 sliding along the down-sliding rail 5. Both ends of the down-sliding rail 5 are respectively provided with ring hoops 9, and the ring hoop 9 is used for hooping the down-sliding rail 5 to provide a stable fixed platform for it and prevent it from deforming.

The down-sliding rail 5 is provided with a height control device 8 in a vertical direction, an acceleration sensor 7 is provided in the head model 4, and the acceleration sensor 7 is connected to the data acquisition system 2.

The data acquisition system 2 includes a constant-current power adapter 10, a data acquisition card 11, a data storage software, and data transmission cables. The data transmission cables are connected among the acceleration sensor 7, the data acquisition system 2, and the data analysis system 3.

The data analysis system 3 includes software and a computer that outputs and calculates an acceleration measurement value.

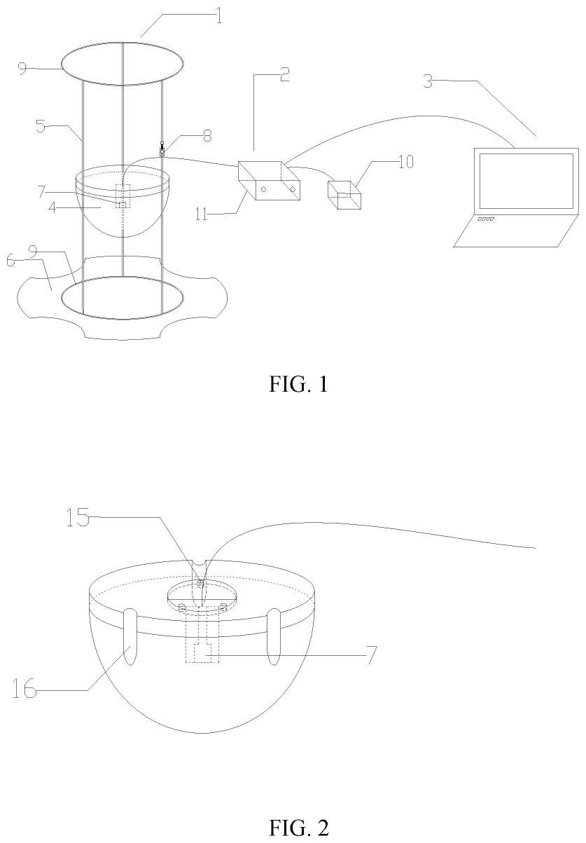

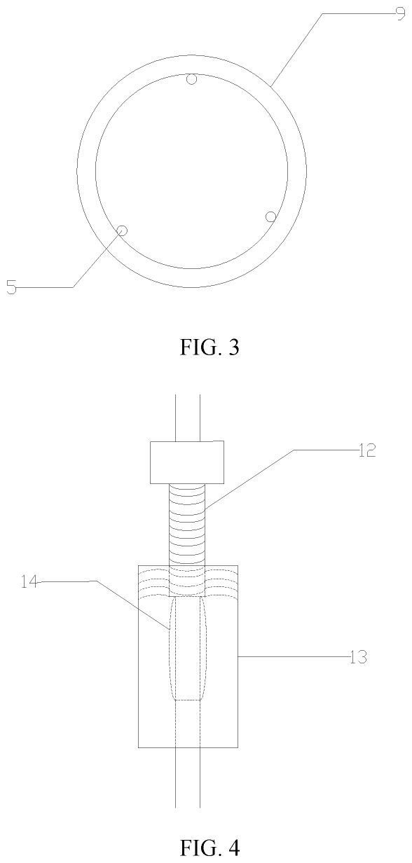

As shown in FIG. 1, FIG. 2 and FIG. 3, a main-body of the head model 4 in FIG. 3 forms in a combination of a hemisphere and an equal radius cylinder. The head model 4 is made of aluminum alloy, and the hemisphere is processed with a diameter of 160 mm±5 mm and a mass of 4.6 kg±0.05 kg. A side of the head model 4 is provided with a corresponding columnar through groove 16, to which the down-sliding rail can be closely attached. The down-sliding rail 5 includes three mutually parallel cylindrical metal rods, each of which has a radius of 9 mm, and the three mutually parallel cylindrical metal rods are hooped at the two ends of the rail by the ring hoop 9 having a certain thickness and an inner diameter of 89 mm. One of down-sliding rails 5, which is configured to install a height adjustment device, is engraved with scale lines having a range of 100 cm and a division value of 10 cm. Each cylindrical rail can be closely attached to the corresponding columnar through groove 16 arranged on the side of the head model 4, without seriously affecting free falling of the head model 4. The height control device 8 includes a bolt 12 and a nut 13 that can slide on the rail. When the bolt 12 and the nut 13 are tightened, a barrel hoop 14 in the nut 13 is pressed to hoop against the rail. When the head model 4 needs to fall at a certain height, a bottom edge of the height control device 8 is aligned with the scale line of the down-sliding rail 5, the bolt 12 is tightened, and the head model 4 is manually lifted to the bottom edge of the height control device 8 and stabilized and then can be released for falling. The supporting base plate 6 is made of metal material, and the supporting base plate 6 is a steel plate to avoid eccentric deformation caused by relatively low overall rigidity of the down-sliding rail 5 and improving overall stability of the collision impact system 1. The supporting base plate 6 is tightly hooped together with the down-sliding rail 5 through the ring hoop 9 having a certain thickness, and the down-sliding rail 5 should be perpendicularly and rigidly connected to the supporting base plate 6. The acceleration sensor 7 is a piezoelectric sensor and configured to measure acceleration in a direction perpendicular to the pavement, and has a range of 1000 g, voltage sensitivity of 20 mv/g, a test frequency range from 0.5 Hz to 10000 Hz, and linearity not greater than 2%. The acceleration sensor 7 is located at a center of gravity of the head model 4, a deviation of an axis of the acceleration sensor 7 from an axis of the head model 4 is smaller than or equal to exceed 5°, and the acceleration sensor 7 and the head model 4 should be tightly connected by the bolt 15.

The present disclosure also provides a method test for testing an apparatus for evaluating a degree of injury to a rider's head colliding with a pavement, and the method includes steps S1 to S4.

At step S1, a test preparation is performed.

The test preparation includes selecting a test site, cleaning a part of the pavement at the test site using a small brush, brushing an inner side of the down-sliding rail 5 with lubricating oil to reduce impact of friction on the falling of the head model 4, connecting the acceleration sensor 7, the power adapter 10, the data acquisition card 11 and the computer data acquisition software, and checking overall running conditions.

At step S2, a test operation is performed.

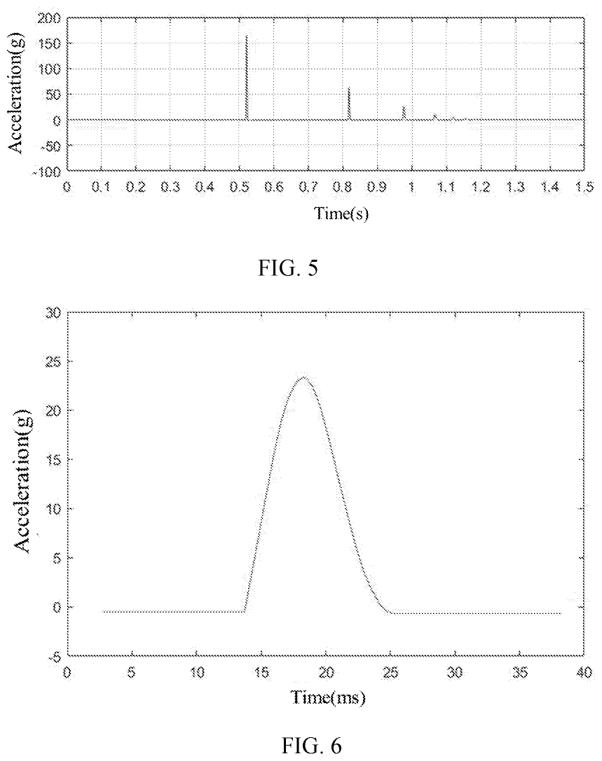

The test operation includes placing the collision impact system 1 at the measuring site, adjusting a height fixing device 8 to a specified position, manually slowly raising the head model 4 to a fixed height, and after ensuring that the head model 4 and each of the three rails 5 are in good contact and readings of the acceleration sensor are stable, releasing the head model 4 to cause it to fall vertically along the rail and collide with and impact on a pavement material. To avoid accidental errors, at each falling height, the releasing is repeated for three times, and data are output, as shown in FIG. 5.

At step S3, a data acquisition is performed.

The data acquisition includes outputting falling time and acceleration data through an acceleration data output port, and after the colliding is completed and the readings have been recorded, stopping reading from the acceleration sensor, and saving the measured acceleration data.

At step S4, a data processing is performed.

The data processing includes linearly fitting a series of two-dimensional coordinates (tᵢ, aᵢ) (i=1, n) of certain moments and vertical accelerations at the certain moments that are obtained by the acceleration sensor, and then plotting a relationship chart between the acceleration and the time.

### Embodiments 1 to 3

A main difference among Embodiments 1 to 3 is that tested target road sections are different. Table 2 shows description of the tested road sections in Embodiments 1 to 3.

TABLE 2
Tested road sections in Embodiments 1 to 3

| | Embodiment 1 | Embodiment 2 | Embodiment 3 |
|---|---|---|---|
| Type of Pavement | Asphalt Concrete | Cement Concrete | Colored Plastic |
| Material | Pavement | Pavement | Runway |
| Conditions of | Intact | Intact | Intact |
| Pavement | | | |
| Type of | Urban Non-motor | Urban Non-motor | Sports Ground |
| Pavement | vehicle Lane | vehicle Lane | |

Implementation processes of Embodiments 1 to 3 adopts the apparatus and the calculation method provided by the present disclosure. The test process follows the test steps provided by the present disclosure.

The head model used in the test is made of aluminum alloy, with a diameter of 162 mm and a weight of 4.62 kg. The acceleration sensor is a piezoelectric sensor for measuring acceleration in a direction perpendicular to the pavement, with a range of 1000 g, the voltage sensitivity of 20 mv/g, a test frequency range from 0.5 Hz to 10000 Hz, and linearity not greater than 2%. The test sites are selected on the road sections illustrated in Embodiments 1 to 3, and three test sites are selected in each embodiment. Then a small brush is used to clean the part of the pavement at the test site.

The acceleration sensor is connected to the power adapter and the computer data acquisition software, and the overall operation condition is checked. The inside of the down-sliding rail is brushed with the lubricating oil to reduce the impact of the friction on the falling of the head model.

The test apparatus is placed at the test site, the falling height of the head model is adjusted through the height fixing device, and heights adjusted by the height adjustment device in Embodiments 1 to 3 are shown in Table 3.

TABLE 3
Falling height of the head model in Embodiments 1 to 3

| | Embodiment 1 | Embodiment 2 | Embodiment 3 |
|---|---|---|---|
| First Falling Height/cm | 10 | 10 | 10 |
| Second Falling | 20 | — | 20 |
| Height/cm | | | |
| Third Falling Height/cm | — | — | 30 |
| Fourth Falling Height/cm | — | — | 40 |
| Fifth Falling Height/cm | — | — | 50 |
| Sixth Falling Height/cm | — | — | 60 |

Then, the head model is manually raised slowly to a lower edge of the height fixing device, and after ensuring that the head model are in good contact with each of the three rails and readings of the acceleration sensor are stable, the head model is released to cause it to fall vertically along the rail and to collide with and impact on the pavement material. To avoid accidental errors, at each falling height, the releasing is repeated for three times, and data are output. After the test is completed, the falling time and the acceleration data are output through the acceleration data output port, and after the collision is completed and readings have been recorded, the reading from the acceleration sensor is stopped, and the measured acceleration data is saved and analyzed.

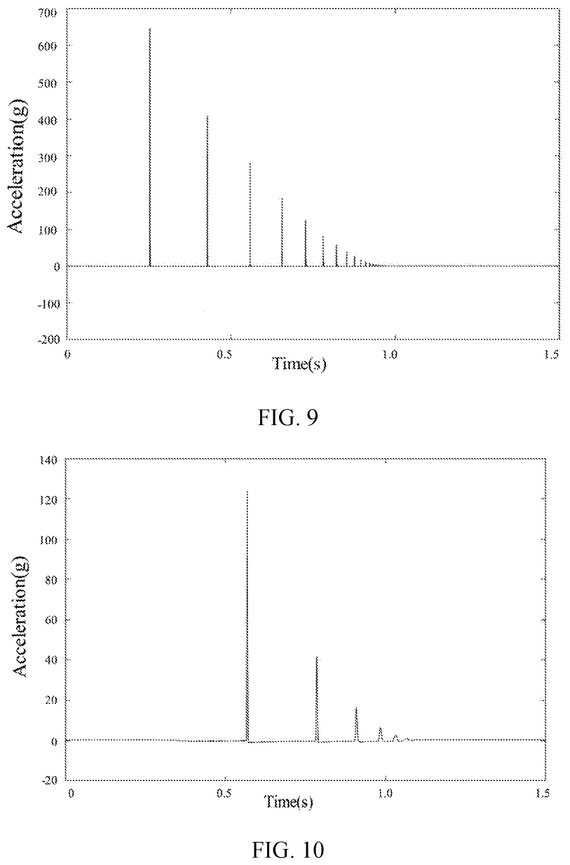

The diagrams of the impact acceleration measured in Embodiments 1 to 3 are as shown in FIG. 8 to FIG. 10.

When processing the data, a series of two-dimensional coordinates of certain moments and vertical acceleration at these moments that are obtained by an acceleration recorder are linearly fitted according to the coordinates, and the TBS value is calculated to determine the possibility of the degree of injury to the rider's head colliding with the pavement. Through the calculation, the TBS values in cases with different falling heights in Embodiments 1 to 3 are shown in Table 4, in which average values of the tests values are shown.

TABLE 4
TBS test values

| | Embodiment 1 | Embodiment 2 | Embodiment 3 |
|---|---|---|---|
| Falling Height 10 cm | 961.0 | 1604.8 | 61.1 |
| Falling Height 20 cm | 1734.2 | — | 189.2 |
| Falling Height 30 cm | — | — | 371.0 |
| Falling Height 40 cm | — | — | 602.8 |
| Falling Height 50 cm | — | — | 880.1 |
| Falling Height 60 cm | — | — | 1238.5 |

The TBS data in Table 4 are substituted into the look-up table of the possibility of the injury degree, and the following can be seen.

In Embodiment 1, when an ordinary male rider rides, if his head collides with the pavement, then in the case where the falling height is 20 cm, the possibility to have fatal head injury is 6%, the possibility to have critical head injury is 29%, the possibility to have serious head injury is 37%, the possibility to have severe fatal head injury is 22%, and the possibility to have moderate head injury is 6%.

In Embodiment 2, when an ordinary male rider rides, if his head collides with the pavement, then in the case where the falling height is 10 cm, the possibility to have fatal head injury is 6%, the possibility to have critical head injury is 29%, the possibility to have serious head injury is 37%, the possibility to have severe fatal head injury is 22%, and the possibility to have moderate head injury is 6%.

In Embodiment 3, when an ordinary male rider rides, if his head collides with the pavement, then in the case where the falling height is 60 cm, the possibility to have fatal head injury is 6%, the possibility to have critical head injury is 24%, the possibility to have serious head injury is 41%, the possibility to have severe fatal head injury is 25%, and the possibility to have moderate head injury is 4%.

The above results indicate that for the asphalt pavement and the cement pavement respectively illustrated in Embodiment 1 and Embodiment 2, in the case where the falling height of the rider is only 10 cm, the rider will almost certainly suffer serious head injury. In another aspect, the plastic track can increase the falling height of the rider to 50 cm, and when the falling height ranges from 30 cm to 40 cm, the head injury suffered by the rider is greatly reduced. The above test results conform to the most basic objective laws. Therefore, as can be seen from Embodiments 1 to 3, the method and the test apparatus disclosed in the present disclosure are real, effective, and fast.

The above is only the preferred embodiment of the present disclosure, and it should be noted that for those of ordinary skill in the art, improvements and modifications can be made on the premise of not deviating from the principle of the present disclosure, and these improvements and modifications should also be regarded as the protection scope of the present disclosure.

What is claimed is:

1. A method for evaluating a degree of injury to a rider's head colliding with a pavement, comprising:
1) for different pavement conditions, calculating a TBS value based on a following formula:
$$TBS = {\{ {( {t}_{2} - {t}_{1} ) [ \frac{{\int }_{{t}_{1}}^{{t}_{2}} a ( t ) dt}{{t}_{2} - {t}_{1}} ]}^{\frac{5}{2}} \}}_{max} ,$$
where a(t) represents a measured composite acceleration in a unit of g, g=9.8 m/s², t₁ and t₂ respectively represent two moments during impact, and t₂-t₁ represents a certain time interval between a beginning moment and an end moment of recording; and
2) determining the degree of the injury using the TBS value, wherein degrees of injury are classified into six levels including mild injury, moderate injury, severe injury, serious injury, critical injury and fatal injury based on degree of injury or threat to a human body, and each of the six levels corresponds to a range of the TBS value for intuitive judgment.

2. The method for evaluating the degree of injury to the rider's head colliding with the pavement according to claim 1, wherein the pavement comprises an asphalt pavement, a concrete pavement, a sidewalk pavement, a bicycle lane elastic pavement, a bridge deck pavement, a sports ground or a safety floor.

3. An apparatus for evaluating a degree of injury to a rider's head colliding with a pavement, comprising:
a collision impact system configured to test acceleration;
a data acquisition system configured to acquire the tested acceleration and store or transmit the tested acceleration; and
a data analysis system configured to receive and analyze the acceleration transmitted from the data acquisition system.

4. The apparatus for evaluating the degree of injury to the rider's head colliding with the pavement according to claim 3, wherein the collision impact system comprises:
a down-sliding rail vertically disposed and provided with a height control device in a vertical direction;
a supporting base plate arranged at a bottom of the down-sliding rail; and
a head model sliding along the down-sliding rail, wherein both ends of the down-sliding rail are respectively provided with ring hoops, an acceleration sensor is provided in the head model, and the acceleration sensor is connected to the data acquisition system.

5. The apparatus for evaluating the degree of injury to the rider's head colliding with the pavement according to claim 4, wherein the data acquisition system comprises:
a constant-current power adapter connected to the acceleration sensor and configured to supply power to the data acquisition system;
a data acquisition card connected to the acceleration sensor; and
data storage software,
wherein the data analysis system includes software and a computer that outputs and calculates a measured acceleration value.

6. The apparatus for evaluating the degree of injury to the rider's head colliding with the pavement according to claim 4, wherein the head model is formed by a combination of a hemisphere and an equal radius cylinder and is made of aluminum alloy, the hemisphere of the head model has a diameter of 160 mm±5 mm and a mass of 4.6 kg±0.05 kg, and a side of the head model is provided with a columnar through groove closely attached to the down-sliding rail.

7. The apparatus for evaluating the degree of injury to the rider's head colliding with the pavement according to claim 4, wherein the down-sliding rail comprises three mutually parallel cylindrical metal rods, each of which has a radius of 9 mm; and each of the ring hoops has an inner diameter of 89 mm.

8. The device for evaluating the degree of injury to the rider's head colliding with the pavement according to claim 4, wherein the acceleration sensor is a piezoelectric sensor and configured to measure acceleration in a direction perpendicular to the pavement, the acceleration sensor is located at a center of gravity of the head model, and a deviation of an axis of the acceleration sensor from an axis of the head model is smaller than or equal to 5°.

9. A method for testing the apparatus for evaluating the degree of injury to the rider's head colliding with the pavement according to claim 3, comprising:
1) test preparation comprising:
selecting a test site, cleaning a part of the pavement at the test site using a small brush, brushing an inner side of a down-sliding rail with lubricating oil to reduce impact of friction on a falling of a head model, connecting an acceleration sensor with a power adapter and computer data acquisition software, and checking overall running conditions;
2) test operation comprising:
placing the collision impact system at the test site, adjusting a height control device to a specified position, manually raising the head model slowly to a fixed height, and after ensuring that the head model and each of three rails are in good contact and readings of the acceleration sensor are stable, releasing the head model to cause it to fall vertically along the down-sliding rail and collide with and impact on a pavement material; and at each of falling heights, repeating the releasing for three times, and outputting data;
3) data acquisition comprising:
outputting falling time and acceleration data through an acceleration data output port, and after the colliding is completed and the readings have been recorded, stopping reading from the acceleration sensor, and saving the measured acceleration data; and
4) data processing comprising:
linearly fitting a series of two-dimensional coordinates (tᵢ, aᵢ) (i=1, n) of certain moments and vertical acceleration at the certain moments that are obtained by the acceleration sensor, and then plotting a relationship chart between acceleration and time.
